(19) United States
(12) Patent Application Publication
(10) Pub. No.: US 2008/0192737 A1
(43) Pub. Date: Aug. 14, 2008

(54) Switching apparatus and path monitoring setting method

(75) Inventors: Keiji Miyazaki, Kawasaki (JP); Akira Nagata, Fukuoka (JP)

Correspondence Address: HANIFY & KING PROFESSIONAL CORPORATION, 1875 K STREET, NW, SUITE 707, WASHINGTON, DC, 20006, US

(73) Assignee: FUJITSU LIMITED

(21) Appl. No.: 12/010,254

(22) Filed: Jan. 23, 2008

(30) Foreign Application Priority Data
Feb. 13, 2007 (JP) 2007-032426

(51) Int. Cl. H04L 12/28

(52) U.S. Cl. 370/360

(57) ABSTRACT

To make reliable settings about pass monitoring in a short time.

I/F parts are connected to other switching apparatuses or terminal units and receive or transmit a signaling message and a packet from or to these other switching apparatuses or terminal units. A route setting part refers to the source address and the destination address of a packet included in a signaling message to determine a path on which the packet will be transferred. A path monitoring control part refers to path monitoring information included in the signaling message as well as a monitoring method memory part and a belonging area memory part in order to make settings about monitoring of the path. The monitoring method memory part stores path monitoring methods to be adopted in the I/F parts. The belonging area memory part stores areas to which the I/F parts belong on a network.

### BACKGROUND

1. Technical Field

The present art relates to a switching apparatus for switching between signal transmission routes and a path monitoring setting method. In particular, the art relates to a switching apparatus that makes reliable settings about path monitoring in a short time, and a path monitoring setting method.

2. Description of the Related Art

In recent years, transmission route (path) setting methods called multi-protocol label switching (MPLS), generalized MPLS (GMPLS), or the like have actively been studied and one of such methods is disclosed in Japanese Unexamined Patent Application Publication No. 2004-80211. The methods such as MPLS and GMPLS cause a switching apparatus that has received a signaling message, such as a router, to make a calculation about a transmission route (route calculation) using a signaling protocol (for example, a resource reservation protocol (RSVP), RSVP-traffic engineering (RSVP-TE), etc.), a routing protocol (for example, open shortest path first (OSPF)), OSPF-traffic engineering (OSPF-TE), or the like. Then, the signaling message is transmitted to the next switching apparatus on a route determined from such a calculation and then a similar calculation is made.

As described above, the methods such as MPLS and GMPLS allow a switching apparatus to independently calculate an efficient transmission route and to set a path from the source to the destination of a signal. This eliminates the need for an operator or the like to previously set up a path, thereby allowing setting of an optimal path in a short time according to the circumstances.

While the above-mentioned methods such as MPLS and GMPLS allow easy setup of a path, they have a problem in that settings about monitoring of each set path need be made manually. Specifically, in order to check such as whether or not a proper connection is established with respect to each set path, an operator must make predetermined settings to switching apparatuses on each path from a management system that manages the network and perform a continuity test or the like on the switching apparatuses. For this reason, monitoring of the path requires time and work and settings about monitoring of the path cannot easily be made, unlike setting of the path.

In the case of a large-scale network or the like, an operator manually makes settings about many switching apparatuses. Therefore, human error may occur and there is a limitation in monitoring the path reliably.

### SUMMARY

An advantage of the present art is to provide a switching apparatus that makes reliable settings about path monitoring in a short time, and a monitoring setting method.

According to a first aspect of the present art, a switching apparatus for switching between transmission routes of a signal includes receiving part for receiving a signaling message including information on a source of a signal and information on a destination of the signal; a determining part for determining a transmission route from the source to the destination specified by the signaling message received by the reception part; a setting part for setting a data concerned with monitoring of the transmission route determined by the determining part on a basis of path monitoring information included in the signaling message received by the receiving part; and transmitting part for transmitting the signaling message set the data concerned with monitoring of the transmission route by the setting part, onto the transmission route determined by the determining part.

In the switching apparatus according to the first aspect of the present art, the setting part preferably sets a start point and an end point of the monitoring of the transmission route according to areas to which the receiving part and the transmitting part belong on a network.

In the switching apparatus according to the first aspect of the present art, if the receiving part and the transmitting part belong to different areas of a network, the setting part preferably sets the receiving part to the end point of the monitoring and the transmitting part to the start point of the monitoring.

In the switching apparatus according to the first aspect of the present art, if the receiving part and the transmitting part belong to an identical area of a network, the setting part sets the receiving part and the transmitting part to relay points of the monitoring.

The switching apparatus according to the first aspect of the present art further includes memory part for storing monitoring methods corresponding to the receiving part and the transmitting part. The setting part preferably causes the memory part to store a monitoring method specified by the pass monitoring information.

In the switching apparatus according to the first aspect of the present art; the memory part preferably stores a default monitoring method in advance.

The switching apparatus according to the first aspect of the present art further includes notice part for, upon executing monitoring of the transmission route according to the setting made by the setting part, notifying of a result of the monitoring.

In the switching apparatus according to the first aspect of the present art, the notice part preferably stores a notice destination of a monitoring result corresponding to each monitoring method and notifies a notice destination corresponding to a monitoring method adopted in the executed monitoring, of the monitoring result.

In the switching apparatus according to the first aspect of the present art, the receiving part preferably receives a signaling message including path monitoring information including an action flag indicating whether to execute monitoring of the transmission route.

In the switching apparatus according to the first aspect of the present art, the transmitting part preferably transmits a signaling message including path monitoring information including an end flag indicating whether or not monitoring of the transmission route has been completed.

In the switching apparatus according to the first aspect of the present art, the transmitting part preferably transmits a signaling message including path monitoring information including a result of monitoring of the transmission route.

In the switching apparatus according to the first aspect of the present art, the transmitting part preferably transmits a signaling message including path monitoring information including a notice destination of a result of monitoring of the transmission route.

According to a second aspect of the present art, in a switching apparatus for switching between transmission routes of a signal, a method for making a setting about path monitoring includes receiving a signaling message including information on a source of a signal and information on a destination of the signal; determining a transmission route from the source to the destination specified by the signaling message received in the receiving step; making a setting about monitoring of the transmission route determined by the determining step, according to path monitoring information included in the signaling message received in the receiving step; and transmitting the signaling message on which the setting made in the setting step is reflected, onto the transmission route determined in the determining step.

According to the first aspect of the present art, a signaling message including information on a source of a signal and information on a destination of the signal is received, a transmission route from the source to the destination specified by the received signaling message is determined, a setting about monitoring of the transmission route is made according to path monitoring information included in the received signaling message, and the signaling message on which the setting is reflected is transmitted onto the transmission route. Therefore, a setting about monitoring of the path is automatically made at the same time when the path is set. This eliminates the need for manually making a setting about monitoring of the path and makes a reliable setting about monitoring of the path in a short time.

Also, the start point and the end point of monitoring of the transmission route are set according to the areas to which the interface that receives the signaling message and the interface that transmits the signaling message belong on a network. Therefore, for example, if the network is divided into multiple regions, such as areas or domains, the start point and the end point of monitoring of the path are set according to these regions.

Also, if the reception interface and the transmission interface belong to different regions on the network, the reception interface is set to the end point of the monitoring and the transmission interface is set to the start point of the monitoring. Therefore, the reception interface and the transmission interface of the switching apparatus positioned on the boundary of the regions are set to the end point and start point, respectively, of monitoring of the path.

Also, if the reception interface and the transmission interface belong to an identical region on the network, the reception interface and the transmission interface are set to relay points of the monitoring. Therefore, the input interface and the output interface of the switching apparatus positioned within the region are set to an identical target for monitoring of the path.

Also, monitoring methods specified by the pass monitoring information are stored in the memory for storing the monitoring methods corresponding to the reception interface and the transmission interface. Therefore, monitoring methods are separately set to the interface to which the signaling message is inputted and the interface that outputs the signaling message.

Also, the default monitoring method is previously stored. Therefore, even if no monitoring method is specified in the path monitoring information, monitoring of the path is executed using the default monitoring method.

Also, after having executed monitoring of the set transmission route, the result of the path monitoring is notified of, for example, to a management system that manages the network.

Also, the notice destination of a monitoring result corresponding to each monitoring method is stored and the monitoring result is notified of to the notice destination corresponding to the monitoring method adopted in the executed monitoring. Therefore, the notice destination of the monitoring result, such as the management system or the start point and/or the end point of the path monitoring, is changed in accordance with the adopted monitoring method.

Also, a signaling message including path monitoring information including an action flag indicating whether to execute monitoring of the transmission route is received. Therefore, whether to execute monitoring of the path is set in the signaling message when the path is set.

Also, a signaling message including path monitoring information including an end flag indicating whether or not monitoring of the transmission route has been completed is transmitted. Therefore, whether or not monitoring of the path has been completed is notified of to another switching apparatus or terminal unit using the signaling message after the path has been set.

Also, a signaling message including path monitoring information including the result of monitoring of the transmission route is transmitted. Therefore, the result of the path monitoring is notified of to another switching apparatus or terminal unit using the signaling message after the path has been set.

Also, a signaling message including path monitoring information including the notice destination of the result of monitoring of the transmission route is transmitted. Therefore, the notice destination of the result of the path monitoring is notified of to another switching apparatus or terminal unit using the signaling message after the path has been set.

### BRIEF DESCRIPTION OF THE DRAWINGS

FIG. 1 is an example of a network configuration according to an embodiment of the present art;

FIG. 2 is a block diagram showing a main configuration of a switching apparatus according to this embodiment;

FIG. 3 is a diagram showing an example of a signaling message according to this embodiment;

FIG. 4 is a diagram showing an example of a monitoring method according to this embodiment;

FIG. 5 is a diagram showing an example of area division according to this embodiment;

FIG. 6 is a diagram showing an example of a list of belonging areas according to this embodiment;

FIG. 7 is a diagram showing an example of notice destinations of a monitoring result according to this embodiment;

FIG. 8 is a flowchart showing operations of the switching apparatus according to this embodiment;

FIG. 9 is a diagram showing an example of path monitoring information according to another embodiment of the present art; and

FIG. 10 is a diagram showing an example of path monitoring information according to yet another embodiment of the present art.

### DESCRIPTION OF THE. PREFERRED EMBODIMENTS

An embodiment of the present art will now be described in detail with reference to the accompanying drawings. A case in which MPLS, GMPLS, or the like causes a switching apparatus that has received a signaling message for setting a new path to independently set a path according to a signaling protocol will be described below. The present art is applicable to cases in which a switching apparatus that has received a predetermined massage independently sets a transmission path. While the present art will be described using packet transfer in the Ethernet (trademark) or Layer 2 as an example, the art is also applicable to cases in which a switching apparatus switches between transmission routes, such as frames in time division multiplexing (TDM) or optical wavelengths in wavelength division multiplexing (WDM).

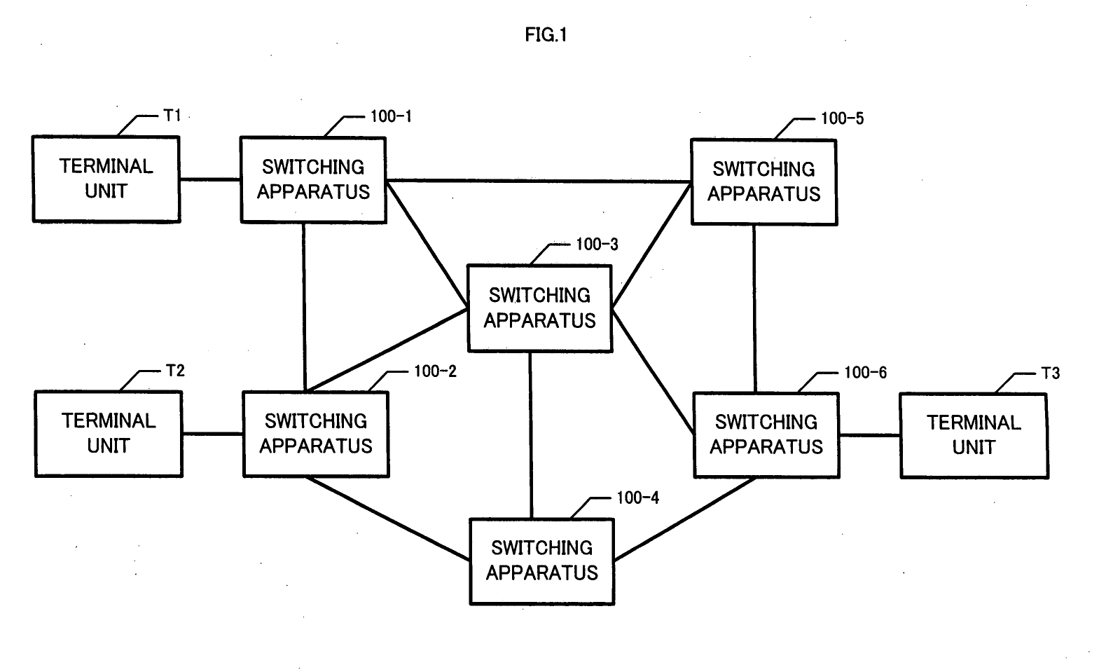

FIG. 1 is a diagram showing an example of a network configuration according to the embodiment of the present art. In the illustrated network, three terminal units T1 to T3 are connected to one another via switching apparatuses 100-1 to 100-6. For example, if a packet is transferred from the terminal unit T1 to the terminal unit T3, a signaling message for setting a path is transmitted from the terminal unit T1 to the switching apparatus 100-1 prior to such packet transfer. Upon receipt of the signaling message, the switching apparatus 100-1 selects a path on which the packet will be efficiently transferred to the terminal unit T3, and transmits the signaling message to a switching apparatus on the selected path. For example, the signaling message is transmitted to the switching apparatus 100-3.

Also, upon receipt of the signaling message, the switching apparatus 100-1 makes settings for monitoring the selected path. Specifically, the area to which the switching apparatus 100-1 belongs on the network, the prescribed monitoring method, and the like are set for the switching apparatus 100-1. These settings will be described in detail later.

As with the switching apparatus 100-1, upon receipt of the signaling message, the switching apparatus 100-3 selects a path and makes settings for monitoring the selected path. As described above, upon receipt of the signaling message, any one of the switching apparatuses 100-1 to 100-6 selects an efficient path and makes settings for monitoring the selected path, and transmits the signaling message to the next switching apparatus on the path, which is any one of the other switching apparatuses. Thus, efficient paths from the terminal unit T1 to the terminal unit T3 are set and settings for monitoring the paths, such as a continuity test to be conducted periodically, are made.

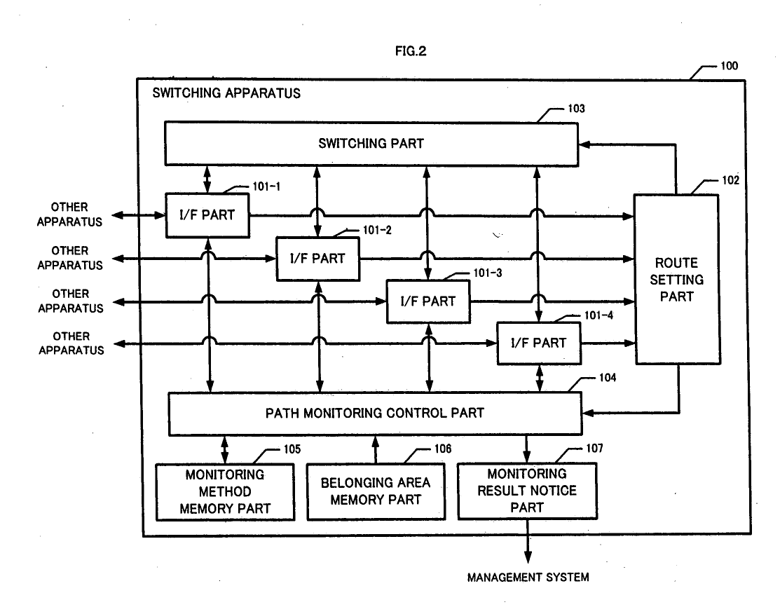

FIG. 2 is a block diagram showing a main configuration of a switching apparatus 100 according this embodiment. The illustrated switching apparatus 100 shows the configuration of the switching apparatuses 100-1 to 100-6. Specifically, the switching apparatus 100 includes interface parts (hereafter refereed to as “I/F parts”) 101-1 to 101-4, a route setting part 102, a switching part 103, a path monitoring control part 104, a monitoring method memory part 105, a belonging area memory part 106, and a monitoring result notice part 107.

The I/F parts 101-1 to 101-4 are connected to other switching apparatuses or terminal units and receive or transmit a signaling message or a packet from or to such other switching apparatuses or terminal units. Upon receipt of a signaling message from another switching apparatus or terminal unit, any one of the I/F parts 101-1 to 101-4 outputs this signaling message to the route setting part 102 and path monitoring control part 104.

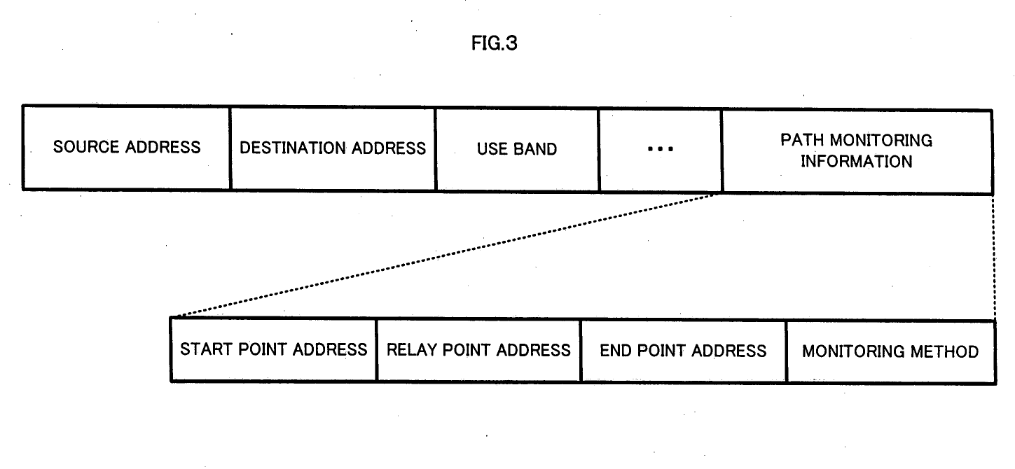

For example, a signaling message according to this embodiment has a format as shown in FIG. 3. Specifically, the signaling message according to this embodiment includes a source address and a destination address indicating the source and destination, respectively, of a packet, a use band indicating a band to be used to transfer the packet, and path monitoring information indicating information on path monitoring. The path monitoring information includes a start point address indicating an apparatus to serve as the start point of the path monitoring, a relay address indicating an apparatus to serve as the relay point of the path monitoring, an end address indicating an apparatus to serve as the end point of the path monitoring, and a monitoring method that indicates a method for monitoring the path from the start point to the end point. These pieces of information included in the path monitoring information are updated as necessary by the path monitoring control part 104 to be discussed later.

Upon receipt of the data packet from another switching apparatus or terminal unit, any one of the I/F parts 101-1 to 101-4 outputs this packet to the switching part 203. Further, any one of the I/F parts 101-1 to 101-4 transmits the packet outputted from the switching part 103 and the signaling message outputted from the path monitoring control part 104, to another switching apparatus or terminal unit connected to itself. While the switching apparatus 100 includes the four interface parts, that is, the I/F parts 101-1 to 101-04 in this embodiment, the number of interface parts of the switching apparatus 100 may be arbitrary if the number is two or more.

The route setting part 102 refers to the source address and destination address of the packet included in the signaling message and uses a signaling protocol, such as RSVP or RSVP-TE, in order to determine a path on which the packet is efficiently transferred. Then, the route setting part 102 notifies the switching part 103 and the path monitoring control part 104 of a switching apparatus or a terminal unit to which the packet is subsequently to be transferred on the selected path.

The switching part 103 outputs the packet outputted from any one of the I/F parts 101-1 to 101-4, to any one of the I/F parts 101-1 to 101-4 that is notified of to the switching part 103 by the route setting part 102 and is connected to another switching apparatus or terminal unit. Thus, the paths on which the packet is transferred are appropriately switched.

Upon receipt of the signaling message from any one of the I/F parts 101-1 to 101-4, the path monitoring control part 104 refers to path monitoring information included in this signaling message and the monitoring method memory part 105 and the belonging area memory part 106 in order to make settings about monitoring of the path determined by the route setting part 102.

Specifically, the path monitoring control part 104 determines to which of the start point, the relay point, and the end point of the path monitoring the I/F part to which the signaling message has been inputted from another switching apparatus or terminal unit and the I/F part that will output the signaling message to another switching apparatus or terminal unit each correspond. At that time, the path monitoring control part 104 refers to the belonging area memory part 106 to check whether or not these I/F parts belong to the same area. If these I/f parts belong to the same area, the path monitoring control part 104 determines that these I/F parts correspond to relay points; if not, it determines that the input I/F part is the end point and the output I/F part is the start point. Then, the path monitoring control part 104 updates the start point address, relay point address and end point address included in the path monitoring information contained in the signaling message.

Also, the path monitoring control part 104 refers to the monitoring methods included in the path monitoring information contained in the signaling message in order to set the methods for monitoring the path that passes through the I/F parts. Specifically, the path monitoring control part 104 stores the monitoring methods included in the path monitoring information, in the monitoring method memory part 105 in such a manner that the monitoring methods are related to the I/F parts 101-1 to 101-4. Subsequently, the path monitoring control part 104 outputs the signaling message in which the start point address, relay point address, and end point address have been updated, to any one of the I/F parts 101-1 to 101-4 that is notified of to the path monitoring control part 104 by the route setting part 102 and is connected to another switching apparatus or terminal unit.

Further, the path monitoring control part 104 actually executes the path monitoring set as described above and outputs the result of the path monitoring to the monitoring result notice part 107. The path monitoring control part 104 may also notify the start point and/or the end point of the path that are targets for the monitoring, of the monitoring result. The destinations to which the monitoring result is to be notified of are stored in the monitoring result notice part 107, as will be described later.

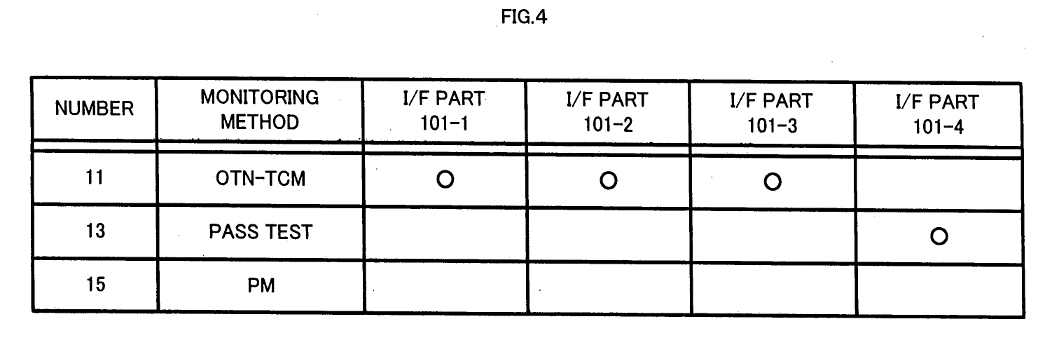

The monitoring method memory part 105 stores the pass monitoring methods to be adopted in the I/F parts 101-1 to 101-4. Specifically, as shown in FIG. 4, the monitoring method memory part 105 includes a list of the monitoring methods, which are to be adopted in the I/F parts 101-1 to 101-4. For example, the monitoring method memory part 105 sets the default of the monitoring methods to be adopted in the I/F parts 101-1 to 101-4, to “optical transport network-tandem connection monitoring (OTN-TCM)”. If the monitoring methods are specified by the path monitoring information included in the signaling message, the default monitoring method is changed to the specified monitoring methods. FIG. 4 shows an example in which “continuity test” is specified as the monitoring method for the I/F part 101-4 by the signaling message.

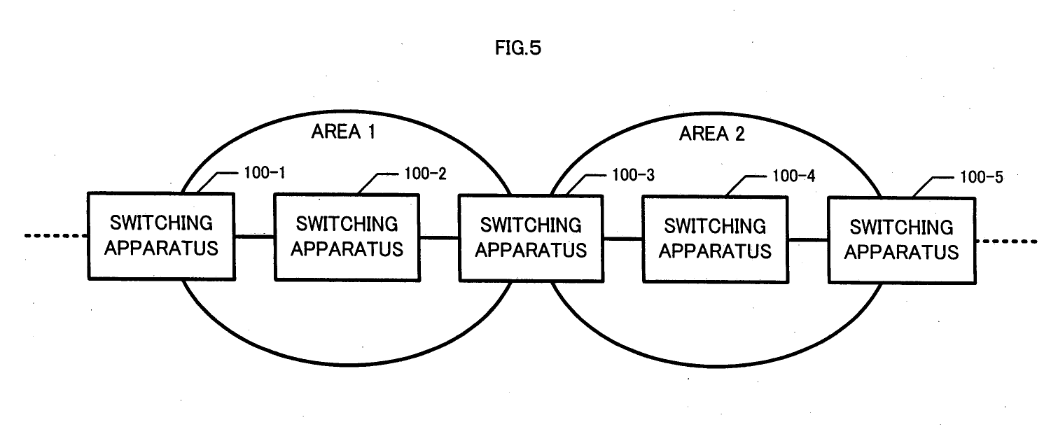

The belonging area memory part 106 stores the areas to which the I/F parts 101-1 to 101-4 of the switching apparatus 100 belong on the network. When the path monitoring control part 104 makes settings about monitoring of a path, it is notified of the areas to which I/F parts on the path belong. For example, if the switching apparatus 100 is set up on a large-scale network in this embodiment, the network may be divided into multiple areas, as shown in FIG. 5. In this case, although switching apparatuses exchange detailed information on routing of a packet with one another within each area, such detailed information is not exchanged between the areas.

In FIG. 5, the switching apparatuses 100-1, 100-3, and 100-5 are positioned on the boundaries of areas. In these switching apparatuses, an I/F part to which a signaling message is inputted and an I/F part that outputs the signaling message belong to different areas and serve as the end point and the start point, respectively, of path monitoring. In other words, path monitoring is executed separately in the switching apparatuses 100-1, 100-2, and 100-3 and in the switching apparatuses 100-3, 100-4, and 100-5.

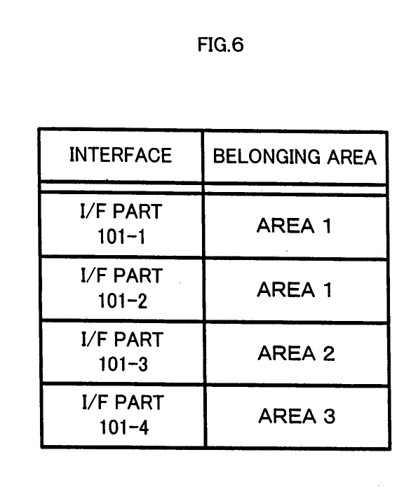

For example, the belonging area memory part 106 stores the areas to which the I/F parts 101-1 to 101-4 belong, in a format as shown in FIG. 6. In this case, if a signaling message is inputted/outputted into/from the I/F part 101-1 and the I/F part 101-2, these I/F parts serve as the relays of the path monitoring. If a signaling message is inputted/outputted into/from other two I/F parts, one of these two I/F parts, to which the signaling message is inputted, serves as the end point of the path monitoring and the other, which outputs the signaling message, serves as the start point of the path monitoring.

If the network is divided into multiple domains, the belonging area memory part 106 stores the domain to which the switching apparatus 100 belongs as well as stores the domains to which other switching apparatuses or terminal units connected to the I/F parts 101-1 to 101-4 belong. This allows determination of whether or not the I/F parts 101-1 to 101-4 are positioned on the boundary between domains if the switching apparatus 100 belongs to a certain domain and all of the I/F parts 101-1 to 101-4 also belong to the same domain.

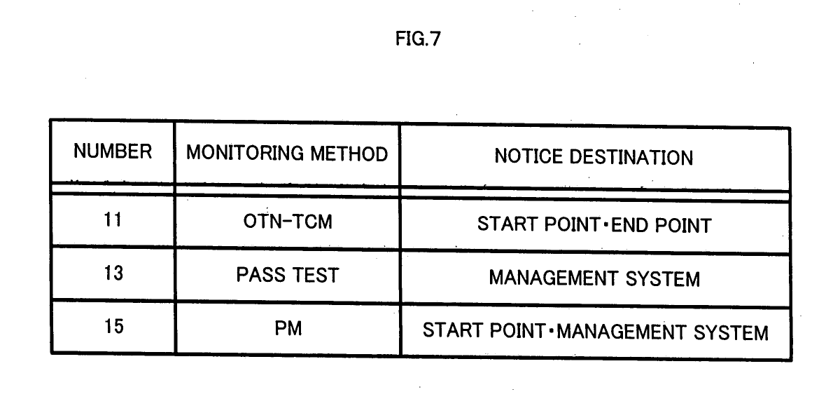

Once the path monitoring control part 104 has executed path monitoring, the monitoring result notice part 107 notifies a management system of the result of the monitoring (see FIG. 2). This is, however, provided that the monitoring result notice part 107 stores the notice destination to be notified of the monitoring result for each monitoring method and that a monitoring method in which the management system is included as the notice destination is adopted. Therefore, in an example shown in FIG. 7, only if path monitoring in which “continuity test” or “path monitoring (PM)” is adopted as the monitoring method is executed, the monitoring result notice part 107 notifies the management system of the monitoring result.

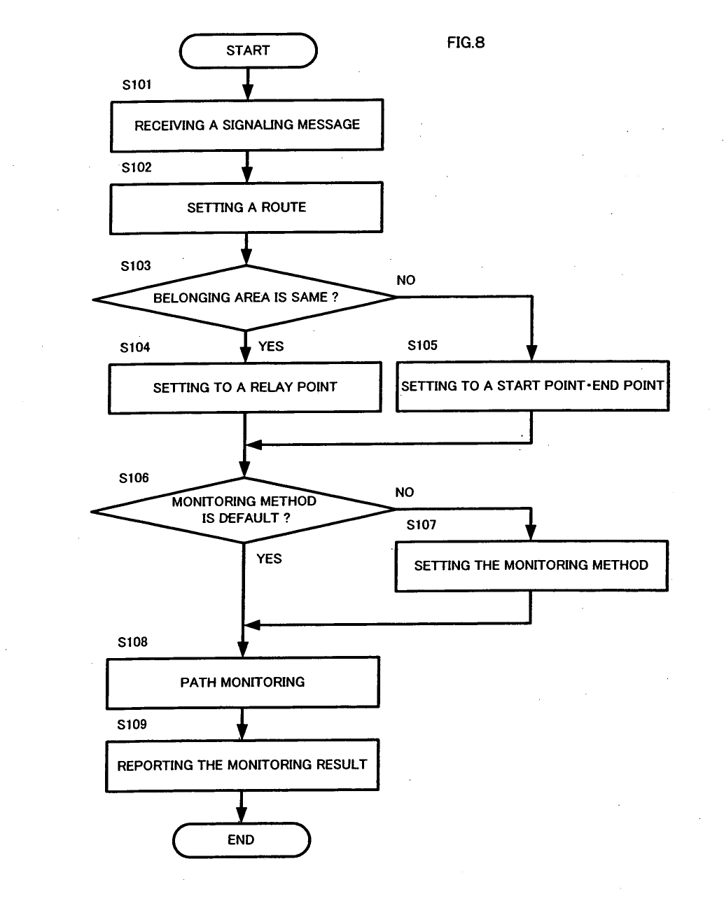

Operations to be performed when path monitoring settings are made in the switching apparatus configured as described above will now be described with reference to a flowchart shown in FIG. 8.

FIG. 8 shows the flow of operations of the switching apparatus.

A signaling message transmitted by another switching apparatus or terminal unit that has completed setting of a path as well as setting of path monitoring is received by an I/F part connected to such another switching apparatus or terminal unit (step S101). For example, the signaling message is received by the I/F part 101-1. The received signaling message is outputted from the I/F part 101-1 to the route setting part 102 and the path monitoring control part 104.

Upon receipt of the signaling message, the route setting part 102 refers to the source address and the destination address included therein to determine a path on which a packet will most efficiently be transferred from the source address to the destination address. Then, the determined path is notified of to the switching part 103, whereby the route through which the packet will be transferred is set (step S102). The path determined by the route setting part 102 is also notified of to the path monitoring control part 104. For example, the signaling message and the packet are transmitted to another switching apparatus or terminal unit connected to the I/F part 101-2 via the determined path.

Upon being notified of the path determined by the route setting part 102, the path monitoring control part 104 reads the areas to which the I/F part 101-1 and 101-2 on the path belong, from the belonging area memory part 106. Then, the path monitoring control part 104 determines whether or not the I/F part 101-1 to which the signaling message and the packet have been inputted from another switching apparatus or terminal unit and the I/F part 101-2 that will output the signaling message and the packet to another switching apparatus or terminal unit belong to the same area (step S103).

If these I/F parts belong to the same area (step S103: YES), it is understood that the switching apparatus 100 is the relay point of the path monitoring. Therefore, the path monitoring control part 104 adds the address of the switching apparatus 100 to the relay point address included in the signaling message (step S104).

If these I/F parts do not belong to the same area (step S103: NO), it is understood that the switching apparatus 100 is positioned on the boundary between areas and, therefore serves as the end point and the start point of the pass monitoring. Therefore, the path monitoring control part 104 adds the address of the switching apparatus 100 to the end point address included in the received signaling message, as well as generates a new message in which the address of the switching apparatus 100 serves as the start point address (step S105). Note that the generated message includes the same information as that included in the received signaling message except for the pass monitoring information.

Subsequently, the path monitoring control part 104 refers to the monitoring methods included in the signaling message in order to store a path monitoring method to be adopted in the I/F part 101-1 to which the signaling message has been inputted, in the monitoring method memory part 105. If no monitoring method is specified in the signaling message, the monitoring method memory part 105 continuously stores the default method as the method for monitoring the I/F part 101-1 to 101-4. Therefore, it is sufficient for the path monitoring control part 104 to determines whether or not the monitoring method specified in the signaling message is the default method (step S106) and to set the path monitoring method to be adopted in the I/F part 101-1, in the monitoring method memory part 105 (step S107) only if a monitoring method other than the default method is specified in the signaling message (step S106: NO).

Then, the path monitoring control part 104 outputs the signaling message in which the start address, relay point address, and end point address have been updated, to the I/F part 101-2 connected to the next switching apparatus or terminal unit on the path determined by the route-setting part 102. Thus, the signaling message is transmitted from the I/F part 101-2. This means that settings about monitoring of the path that includes the I/F parts 101-1 and 101-2 of the switching apparatus 100 has been made. That is, the settings about to which of the start point, relay point, and end point of the path monitoring the I/F parts 101-1 and 101-2 each correspond have been made. Further, the monitoring methods to be adopted in the I/F parts 101-1 and 101-2 have been set.

Upon making the path monitoring settings, the path monitoring control part 104 actually executes the path monitoring (step S108). At this time, the path monitoring control part 104 performs the path monitoring on the start point, relay point, and end point of the path monitoring determined when the path monitoring settings have been made, according to the monitoring methods stored in the monitoring method memory part 105. Then the path monitoring control part 104 notifies the monitoring result notice part 107 of the result of the monitoring. If any monitoring method requires that the monitoring result be notified of to the management system, the monitoring result notice part 107 does so. If a monitoring method in which the start point and/or end point of the path monitoring are specified as the destinations to which the monitoring result is notified of is adopted, the path monitoring control part 104 notifies the start point and/or end point of the monitoring result (step S109).

As described above, according to this embodiment, settings necessary for path monitoring to be executed in a switching apparatus, such as setting of the start point, relay point, and end point of the path monitoring and the monitoring methods, are made when a signaling message for setting a path is received. Therefore, at the same time when a path necessary to transfer a packet is set, settings necessary to watch the path are automatically made. This eliminates the need for manually making settings about monitoring the path and makes reliable settings for monitoring the path in a short time.

While, in this embodiment, the start point address, the relay address, the end point address, and the monitoring method are included in the path monitoring information in the signaling message, the path monitoring information according the present art is not limited to these pieces of information.

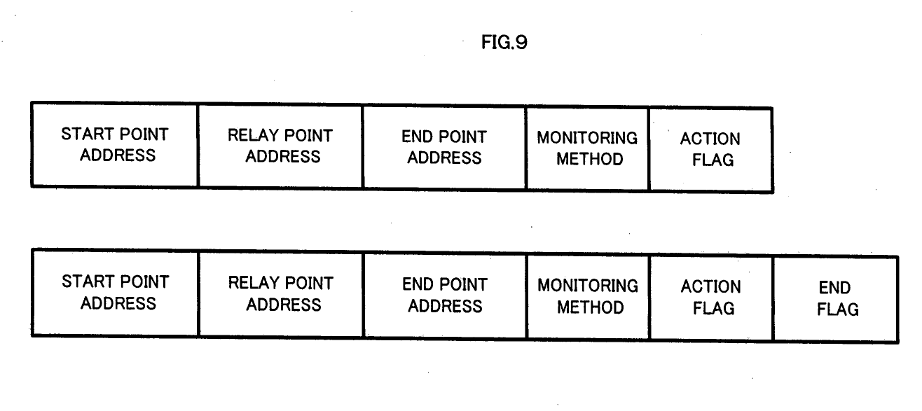

For example, as shown in FIG. 9, an action flag indicating whether to execute path monitoring may be provided in the path monitoring information so that whether to perform path monitoring on the start point, relay point, and end point of each path is specified using the signaling message. Also, an end flag indicating whether or not the path monitoring has been completed may be provided in the path monitoring information so that the completion of the path monitoring is notified of to the start point, the end point, or the like.

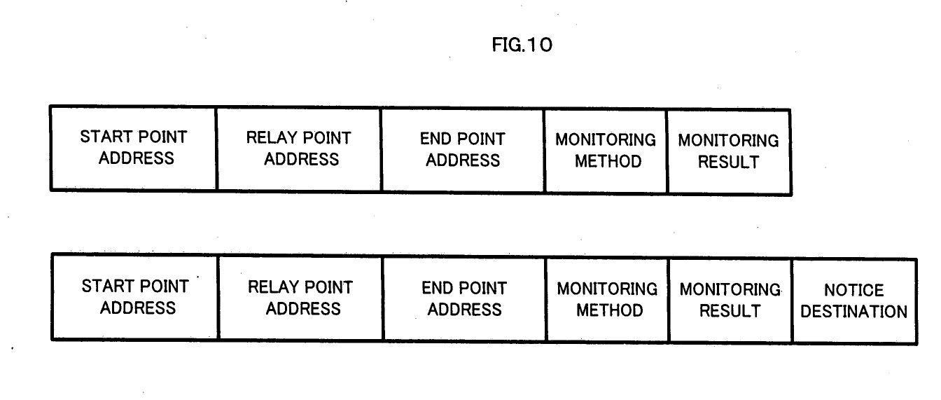

Further, as shown in FIG. 10, the result of the path monitoring may be provided in the path monitoring information so that the monitoring result is notified of to the start point, the end point, or the like. In this case, the destination to which the monitoring result is notified of may be provided in the path monitoring information so that a switching apparatus that will receive a signaling message including this path monitoring information will determine the destination to which the signaling message including the monitoring result is transmitted.

Furthermore, these pieces of path monitoring information may be included not only in a signaling message to be transmitted from the source to the destination but also in a response signaling message to be transmitted from the destination to the source in response to the signaling message.

What is claimed is:

1. A switching apparatus comprising:
a receiving part for receiving a signaling message including information on a source of a signal and information on a destination of the signal;
a determining part for determining a transmission route from the source to the destination specified by the signaling message received by the receiving part;
a setting part for setting a data concerned with monitoring of the transmission route determined by the determining part on a basis of path monitoring information included in the signaling message received by the receiving part; and
a transmitting part for transmitting the signaling message set the data concerned with monitoring of the transmission route by the setting part, onto the transmission route determined by the determining part.

2. The switching apparatus according to claim 1, wherein the setting part sets a start point and end point of the monitoring of the transmission route according to an area to which the receiving part and transmitting part belong on a network.

3. The switching apparatus according to claim 2, wherein
if the receiving part and the transmitting part belong to different areas on the network, the setting part sets the receiving part to the end point and the transmitting part to the start point of the monitoring.

4. The switching apparatus according to claim 2, wherein
if the receiving part and the transmitting part belong to an identical area on the network, the setting part sets the receiving part and the transmitting part to a relay point of the monitoring respectively.

5. The switching apparatus according to claim 1, further comprising:
a memory part for storing a monitoring method specified by the path monitoring information, related to the receiving part and the transmitting part.

6. The switching apparatus according to claim 5, wherein the memory part stores a default monitoring method previously set.

7. The switching apparatus according to claim 1, further comprising:
a notice part for notifying of a result of the monitoring of the transmission route according to a setting made by the setting part.

8. The switching apparatus according to claim 7, wherein the notice part stores a notice destination of a monitoring result corresponding to each monitoring method, and notifies the notice destination corresponding to each monitoring method adopted in the executed monitoring, of the monitoring result.

9. The switching apparatus according to claim 1, wherein the receiving part receives the signaling message including path monitoring information having an action flag indicating whether to execute monitoring of the transmission route or not.

10. The switching apparatus according to claim 1, wherein the transmitting part transmits the signaling message including path monitoring information having an end flag indicating whether monitoring of the transmission route has been completed or not.

11. The switching apparatus according to claim 1, wherein the transmitting part transmits the signaling message including path monitoring information having a result of monitoring of the transmission route.

12. The switching apparatus according to claim 1, wherein the transmitting part transmits the signaling message including path monitoring information having a notice destination of a result of monitoring of the transmission route.

13. A path monitoring setting method comprising:
receiving a signaling message including information on a source of a signal and information on a destination of the signal;
determining a transmission route from the source to the destination specified by the signaling message received by the receiving step;
setting a data concerned with monitoring of the transmission route determined by the determining step on a basis of path monitoring information included in the signaling message received by the receiving step; and
transmitting the signaling message set the data concerned with monitoring of the transmission route by the setting step, onto the transmission route determined by the determining step.
